(19) United States
(12) Patent Application Publication
(10) Pub. No.: US 2019/0279518 A1
(43) Pub. Date: Sep. 12, 2019

(54) Illustrated, Interactive Thought Map and Methods of Use

(71) Applicant: Stacy Moore, Bellvue, CO (US)

(72) Inventor: Stacy Moore, Bellvue, CO (US)

(21) Appl. No.: 16/295,654

(22) Filed: Mar. 7, 2019

Related U.S. Application Data
(60) Provisional application No. 62/640,179, filed on Mar. 8, 2018.

(51) Int. Cl. G09B 1/16; G09B 5/00; G09B 19/22

(52) U.S. Cl. CPC G09B 1/16; G09B 19/22; G09B 5/00

(57) ABSTRACT

Discovery products, kits and methods using a plurality of illustrated cards are disclosed herein. One or more of the illustrated cards includes a prompt for participant input and the plurality of illustrated cards is configurable to form a thought map when viewed collectively. The illustrated cards can be used in various settings to address a wide range of concepts in an unexpected and lower stress manner.

### CROSS-REFERENCE TO RELATED APPLICATIONS

This application claims the benefit of and priority to U.S. Provisional Patent Application No. 62/640,179, filed Mar. 8, 2018, which is hereby incorporated by reference in its entirety.

### BACKGROUND

Humans spend a significant amount of time and money trying to understand their interaction with the world around them, and various tools are available for guiding this exploratory process. For example, many people engage therapists, life coaches, professional coaches, religious advisors, self-help books and/or online resources to help them explore their role in the ecosystem.

Sometimes an exploratory process involves tools intended to reach the participant's subconscious, such as make-believe play, games, art, music, hypnotism and other modalities. But, with many of these approaches, the participant is aware of a linear or chronological probing that can lead to a “scripted” response that ultimately fails to reach the root of an issue.

### SUMMARY

The present disclosure generally relates to a discovery product capable of randomly exposing a participant(s) to prompts in a fun, creative, lighthearted and non-obtrusive way. After the prompts are answered individually, the pieces of the discovery product can be assembled into a shape that creates a comprehensive view showing the interconnectedness of concepts. In an embodiment, the discovery product can be used as an internal processing tool, a self-discovery product, a conversation starter, an educational tool, a career tool, a team-building product, a therapeutic tool, a tool for addressing weighty matters in a less intimidating manner, and the like. For example, a discovery product disclosed herein may be used for self discovery, life coaching, art therapy, mindfulness and meditation, retreats and workshops, book clubs, team building, hospice and medical and rehabilitation situations, personality testing, dating and relationship assessment, anti-bullying education, weight loss, stress management, family counseling, travel decisions, language learning, cultural appreciation, religious understanding, and a variety of other purposes.

In an embodiment, a discovery product disclosed herein may be used to study, treat and/or prevent emotional and/or psychological conditions, such as suicidal thoughts, depression, obsessive compulsive disorder (OCD), marriage and relationship problems, financial problems, anxiety, abuse, addiction, codependence, eating disorders, post-traumatic stress disorder (PTSD), grief, sexual identity conflicts, and the like.

In an aspect, a discovery product comprises a plurality of illustrated cards, wherein one or more of the illustrated cards includes a prompt for participant input, the plurality of illustrated cards configurable to form a thought map when viewed collectively.

In an aspect, a discovery kit comprises a discovery product comprising a plurality of illustrated cards, wherein one or more of the illustrated cards includes a prompt for participant input, the plurality of illustrated cards configurable to form a thought map when viewed collectively, and instructions for using the discovery product.

In an embodiment, a discovery kit further comprises a key showing how the illustrated cards are designed to be configured collectively. In most embodiments, the key does not include answers to the prompts. In some embodiments, the key may include answers to the prompts. For example, a key for an educational product may include correct, factual answers to prompts.

In an embodiment, a discovery product disclosed herein is an educational product and answers to prompts are not required to be factually correct answers. For example, a discovery product may be used to develop a plot for a story based on the participant's input.

In an aspect, a method for promoting discovery, comprises providing a plurality of illustrated cards; directing at least one participant to provide input on one or more of the illustrated cards; and instructing the participant to organize the plurality of illustrated cards to be viewed collectively as a thought map. The organization of the plurality of illustrated cards may be according to a key or according to a user's preference.

In an embodiment, there is one participant and the plurality of illustrated cards is provided one at a time to the one participant. In another embodiment, there is one participant and the plurality of illustrated cards is provided all at once to the one participant.

In an embodiment, there are multiple participants and one of the plurality of illustrated cards is provided to each of the multiple participants. In another embodiment, there are multiple participants and all of the plurality of illustrated cards is provided to each of the multiple participants.

In an embodiment, the method for promoting discovery is performed by an electronic device using a series of computer-readable instructions stored in a memory of a processor, where the electronic device comprises a graphical user interface. In an embodiment, the illustrated cards are electronic cards presented on a graphical user interface. In an embodiment, a participant interacts with the electronic device through a user input device or through the graphical user interface. In an embodiment, a record of each participant's input may be stored to a memory of the electronic device and/or transmitted from the electronic device to another electronic device. In an embodiment, multiple participants are contributing to the same discovery product or method through a plurality of electronic devices (e.g., through the Internet).

In an embodiment, a method for promoting discovery further comprises a step of comparing a key to the illustrated cards configured collectively.

In an embodiment, the plurality of illustrated cards comprises four or more cards.

In an embodiment, the illustrated cards comprise drawings, paintings, digital art, photography or a combination thereof. For example, illustrations shown on the illustrated cards may be water-color, charcoal, oil, pencil, pen, marker, acrylic, photographs, digital art and combinations and reproductions thereof.

In an embodiment, the illustrated cards are made of a material selected from the group consisting of card stock, paper, cardboard, paperboard, wood, chalkboard, dry erase board, plastic and combinations thereof. In an embodiment, the illustrated cards are laminated. In an embodiment, an illustrated card is a substantially planar and two-dimensional object, which may be in the shape of a square, a rectangle, a pentagon, a hexagon, a triangle, a circle or a combination thereof. In an embodiment, an illustrated card is a substantially three-dimensional object, such as a block.

In an embodiment, at least one of the plurality of illustrated cards is illustrated on both a top surface and a bottom surface of the card.

In an embodiment, each of the plurality of illustrated cards includes at least one prompt for participant input. In an embodiment, an illustrated card includes two or more prompts for participant input. For example, the prompt(s) may be a blank space associated with a word(s), image(s) and/or symbol(s), a thought bubble, an empty box, a shaded area, a dangling line, a cursor prompt, an electronically designated area or a combination thereof. In an embodiment, a prompt comprises words associated with an illustration of a physical object.

In an embodiment, participant input is written input, illustrative input, verbal input, mental input, manual input, typed input or a combination thereof.

In an embodiment, the plurality of illustrated cards is configured to align edge-to-edge in two-dimensions to form a thought map when viewed collectively. In an embodiment, the plurality of illustrated cards is configured to align edge-to-edge in two-dimensions to form a substantially linear, a substantially square, a substantially rectangular, a substantially circular or a substantially radial thought map when viewed collectively.

In an embodiment, at least one illustration bridges across two or more of the illustrated cards, thereby defining neighboring illustrated cards of the thought map. As used herein, “bridging across two or more cards” can be direct or indirect physical bridging or direct or indirect non-physical bridging, such as a reflection across cards or an object on one card interacting with an object on a neighboring card.

In an embodiment, a participant is encouraged to write down whatever first comes to mind in order to tap into the subconscious mind. In an embodiment, there is no right or wrong answer, and a participant is free to change an answer.

In an embodiment, the presentation of illustrations together with words helps a participant think in a different way than he or she might otherwise, and make unexpected associations. In an embodiment, words and/or illustrations on a card can be interpreted in multiple ways.

In an embodiment, cards of the discovery product are wordless, and prompts for participant input are pictorial. Such embodiments may, for example, be appropriate for young children, illiterate participants and/or mentally challenged participants.

In an embodiment, cards forming a thought map can be rearranged and/or interchanged with cards from a different discovery product.

### BRIEF DESCRIPTION OF THE DRAWING

FIG. 1 is a schematic of a discovery product substantially configured into a thought map, according to an embodiment of the invention.

### DETAILED DESCRIPTION

In general, the terms and phrases used herein have their art-recognized meaning, which can be found by reference to standard texts, journal references and contexts known to those skilled in the art. The following definitions are provided to clarify their specific use in the context of this description.

As used herein, a “discovery product” is a participant-discovery product, a self-discovery product, a partner-discovery product, or a team-discovery product that facilitates insight into a participant's cognitive, emotional or psychological state or a subject-matter discovery (educational) product. For example, a discovery product may prompt a participant(s) to reply to one or more requests for input in a rapid, stream-of-consciousness manner to evoke an answer(s) or other response(s) (e.g., refusal to answer) from a participant's subconscious mind. An educational or subject-matter discovery product may, for example, lead to plot discovery, cultural discovery, scientific discovery and the like.

As used herein, a “thought map” is a visual representation used to organize thoughts, feelings, emotions, factual subject-matter, related concepts, or other information. In an embodiment, a thought map is an interactive puzzle.

The terms “direct and indirect” describe the actions or physical positions of one object relative to another object. For example, an object that “directly” acts upon or touches another object does so without intervention from an intermediary. Contrarily, an object that “indirectly” acts upon or touches another object does so through an intermediary (e.g., a third component).

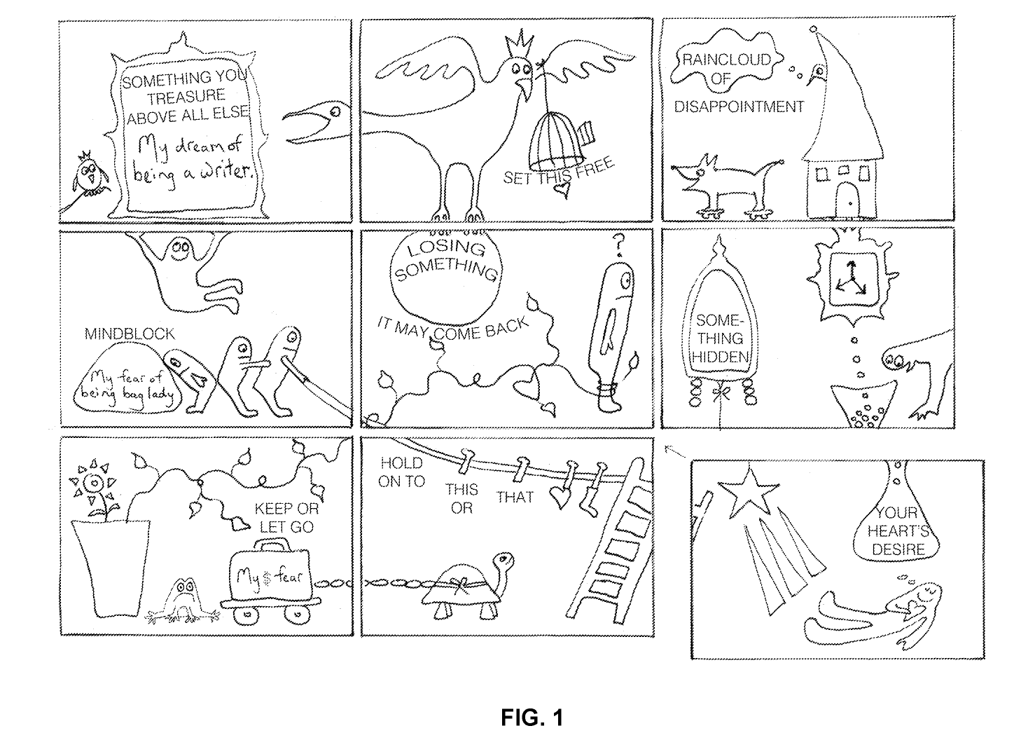

FIG. 1 is a schematic of a discovery product substantially configured into a thought map, according to an embodiment of the invention. As shown, there are nine illustrated cards designed to form a substantially rectangular two-dimensional thought map when configured collectively. Some cards contain a prompt for participant input. The prompt is shown in FIG. 1 as typed font. In the example shown, a participant has provided input, shown as handwritten comments. FIG. 1 also includes some illustrations bridging across two or more of the illustrated cards, thereby defining neighboring illustrated cards of the thought map. For example, an object, such as a vine or clothes line, may physically bridge across neighboring cards. In another example, related objects may bridge across cards in a non-physical manner, such as the character of the middle, lefthand card “supporting” the frame of the top, lefthand card or the character of the central card looking into the “something hidden” mirror of the middle, righthand card and wondering why he is not seeing his reflection.

### STATEMENTS REGARDING INCORPORATION BY REFERENCE AND VARIATIONS

All references cited throughout this application, for example patent documents including issued or granted patents or equivalents; patent application publications; and non-patent literature documents or other source material; are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

The terms and expressions which have been employed herein are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the invention has been specifically disclosed by preferred embodiments, exemplary embodiments and optional features, modification and variation of the concepts herein disclosed can be resorted to by those skilled in the art, and that such modifications and variations are considered to be within the scope of this invention as defined by the appended claims. The specific embodiments provided herein are examples of useful embodiments of the invention and it will be apparent to one skilled in the art that the invention can be carried out using a large number of variations of the devices, device components, and method steps set forth in the present description. As will be apparent to one of skill in the art, methods and devices useful for the present methods and devices can include a large number of optional composition and processing elements and steps. All art-known functional equivalents of materials and methods are intended to be included in this disclosure. Nothing herein is to be construed as an admission that the invention is not entitled to antedate such disclosure by virtue of prior invention.

When a group of substituents is disclosed herein, it is understood that all individual members of that group and all subgroups are disclosed separately. When a Markush group or other grouping is used herein, all individual members of the group and all combinations and subcombinations possible of the group are intended to be individually included in the disclosure.

It must be noted that as used herein and in the appended claims, the singular forms “a”, “an”, and “the” include plural reference unless the context clearly dictates otherwise. Thus, for example, reference to “a card” includes a plurality of such cards and equivalents thereof known to those skilled in the art, and so forth. As well, the terms “a” (or “an”), “one or more” and “at least one” can be used interchangeably herein. It is also to be noted that the terms “comprising”, “including”, and “having” can be used interchangeably. The expression “of any of claims XX-YY” (wherein XX and YY refer to claim numbers) is intended to provide a multiple dependent claim in the alternative form, and in some embodiments is interchangeable with the expression “as in any one of claims XX-YY.”

Unless defined otherwise, all technical and scientific terms used herein have the same meanings as commonly understood by one of ordinary skill in the art to which this invention belongs. Although any methods and materials similar or equivalent to those described herein can be used in the practice or testing of the present invention, the preferred methods and materials are described.

Whenever a range is given in the specification, for example, a range of integers, a temperature range, a time range, a composition range, or concentration range, all intermediate ranges and subranges, as well as all individual values included in the ranges given are intended to be included in the disclosure. As used herein, ranges specifically include the values provided as endpoint values of the range. As used herein, ranges specifically include all the integer values of the range. For example, a range of 1 to 100 specifically includes the end point values of 1 and 100. It will be understood that any subranges or individual values in a range or subrange that are included in the description herein can be excluded from the claims herein.

As used herein, “comprising” is synonymous and can be used interchangeably with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. In each instance herein any of the terms “comprising”, “consisting essentially of” and “consisting of” can be replaced with either of the other two terms. The invention illustratively described herein suitably can be practiced in the absence of any element or elements, limitation or limitations which is/are not specifically disclosed herein.

What is claimed is:

1. A discovery product comprising:
a plurality of illustrated cards, wherein one or more of the illustrated cards includes a prompt for participant input, the plurality of illustrated cards configurable to form a thought map when viewed collectively.

2. The discovery product of claim 1, wherein the prompt is a blank space associated with a word(s), image(s) and/or symbol(s), a thought bubble, an empty box, a shaded area, a dangling line, a cursor prompt, an electronically designated area or a combination thereof.

3. The discovery product of claim 1, wherein the prompt comprises words associated with an illustration of a physical object.

4. The discovery product of claim 1, wherein the participant input is written input, illustrative input, verbal input, mental input, manual input or a combination thereof.

5. The discovery product of claim 1, wherein the plurality of illustrated cards is configured to align edge-to-edge in two-dimensions to form the thought map when viewed collectively.

6. The discovery product of claim 1, wherein at least one illustration bridges across two or more of the illustrated cards, thereby defining neighboring illustrated cards of the thought map.

7. The discovery product of claim 1, wherein the illustrated cards comprise drawings, paintings, digital art, photography or a combination thereof.

8. The discovery product of claim 1, wherein the illustrated cards are made of a material selected from the group consisting of card stock, paper, cardboard, paperboard, wood, chalkboard, dry erase board, plastic and combinations thereof.

9. The discovery product of claim 1, wherein at least one of the plurality of illustrated cards is illustrated on both a top surface and a bottom surface of the card.

10. The discovery product of claim 1 further comprising a key showing how the illustrated cards are designed to be configured collectively.

11. The discovery product of claim 1, wherein the plurality of illustrated cards comprises four or more cards.

12. The discovery product of claim 1, wherein each of the plurality of illustrated cards includes a prompt for participant input.

13. The discovery product of claim 1, wherein the illustrated cards are electronic cards presented on a graphical user interface.

14. A method for promoting discovery, comprising:
providing a plurality of illustrated cards;
directing at least one participant to provide input on one or more of the illustrated cards; and
instructing the participant to organize the plurality of illustrated cards to be viewed collectively as a thought map.

15. The method of claim 14, wherein there is one participant and the plurality of illustrated cards is provided one at a time to the one participant.

16. The method of claim 14, wherein there is one participant and the plurality of illustrated cards is provided all at once to the one participant.

17. The method of claim 14, wherein there are multiple participants and one of the plurality of illustrated cards is provided to each of the multiple participants.

18. The method of claim 14, wherein there are multiple participants and all of the plurality of illustrated cards is provided to each of the multiple participants.

19. The method of claim 14, wherein the method is performed by an electronic device using a series of computer-readable instructions stored in a memory of a processor, the electronic device further comprising a graphical user interface.

20. The method of claim 14 further comprising a step of comparing a key to the illustrated cards configured collectively.
